(19) United States
(12) Patent Application Publication
(10) Pub. No.: US 2020/0160352 A1
(43) Pub. Date: May 21, 2020

(54) METHOD AND SYSTEM FOR IDENTIFYING PRODUCT GENUINENESS

(71) Applicant: MASTERCARD INTERNATIONAL INCORPORATED, Purchase, NY (US)

(72) Inventors: Vipul Mehrotra, Sandila (IN); Ved Pratap Singh Chauhan, Sahibabad (IN); Jaipal Singh Kumawat, Sikar (IN)

(73) Assignee: MASTERCARD INTERNATIONAL INCORPORATED, Purchase, NY (US)

(21) Appl. No.: 16/195,978

(22) Filed: Nov. 20, 2018

(51) Int. Cl. G06Q 30/00; G06Q 30/06; G06Q 20/40; G06Q 20/20; G06Q 20/32; H04L 9/06

(52) U.S. Cl. CPC G06Q 30/0185; G06Q 30/0641; G06Q 20/401; H04L 2209/38; G06Q 20/3276; G06Q 20/322; H04L 9/0637; G06Q 20/202

(57) ABSTRACT

A method for determining product genuineness includes: storing blockchain data for a blockchain, wherein the blockchain data includes a plurality of blockchain data values, each blockchain data value including at least a unique identifier and a genuineness flag; receiving a genuineness request, wherein the genuineness request includes at least a specific identifier associated with a product available for purchase; identifying a specific blockchain data value of the plurality of blockchain data values where the included unique identifier corresponds to the specific identifier; determining genuineness of the product available for purchase based on at least the genuineness flag included in the specific blockchain data value; and transmitting the determined genuineness of the product.

### FIELD

The present disclosure relates to determining the genuineness of a product, specifically the use of a blockchain and unique identifiers affixed to a product available for purchase to determine if the product being purchased is genuine.

### BACKGROUND

As long as products have been created for purchase by consumers, nefarious parties have created counterfeit or knock-off products for sale in an effort to cash in on a more established name or product. While luxury products, such as expensive watches, handbags, perfumes, coats, etc. are often targets for counterfeiting, there is often no limit as to the type of product a counterfeiter may target if there is profit available to be made. In an attempt to combat counterfeiting, product manufacturers often rely on hard-to-replicate designs and manufacturing tricks, etc. However, such methods are typically short-lived, as the counterfeiters will quickly discover how to replicate these designs, either fully or in a manner that is close enough to fool the average consumer.

Another method that some manufacturers used to ensure that only genuine products reach the hands of consumers is to make their products available through trusted retailers. By partnering with merchants, the manufacturer can let their potential customers know what merchants sell their genuine products. Customers can then go to these merchants to be assured of purchasing a product genuinely made by the manufacturer. However, manufacturers have little control over the merchants or their employees to ensure that only genuine products hit the shelves. There is little a manufacturer can do it if an employee takes it on themselves to accept counterfeit products to sell if it is in their financial interest. In some cases, a switch of real products with counterfeit products, or the inclusion of counterfeit products into a shipment, may happen during transit between the manufacturer and the merchant to where both entities may be entirely clueless. This can result in the merchant selling counterfeit products without being aware, where any customer assumes they are buying genuine products due to the partnership between merchant and manufacturer.

Thus, there is a need for a system that can ensure that a product being sold is genuinely made by the manufacturer in a manner that is independently verifiable by merchants and customers alike. Such a system could prevent the introduction of counterfeit products during the distribution of genuine products and solve issues that affect existing methods and systems through improved technology at least over what is described above.

### SUMMARY

The present disclosure provides a description of systems and methods for determining product genuineness. Each product made by a manufacturer is assigned a unique identifier. The unique identifier for each product is stored on a publicly accessible blockchain, which thus creates an immutable record of all genuine products. Before a product is purchased, its identifier is read and a check is made with the blockchain to ensure that the identifier corresponds to a genuine product made by the manufacturer. Once a genuine product has been sold, the blockchain is updated to reflect the sale of that particular genuine product, through its identifier. This way, a consumer can be assured of the genuineness of a product, and also be aware if a genuine product is being resold. The unique identifier may be made difficult to predict (e.g., it is not a sequential number, but rather random (from a random alpha-numeric generator, or randomly picked from a set of random alpha-numeric characters) or pseudo random (i.e., part being random and another part conveying information) with a sufficient number of alternatives to make guessing statistically unlikely (e.g., a trillion possibilities for thousands of products, with the statistical likelihood depending on various factors such as the value of the product and the ability to use long or complicated identifiers). If complicated unique identifiers are used, it can also prevent the attempted use of fake identifiers from a counterfeiter that attempts to copy potential unique identifiers. Additional data may be included in blockchain entries to further protect the genuine product, such as product descriptions or other unique values that may be included on or with the product. As a result, manufacturers, merchants, and consumers may all be protected and ensure that only genuine products are sold to consumers.

A method for determining product genuineness includes: storing, in a memory of a processing server, blockchain data for a blockchain, wherein the blockchain data includes a plurality of blockchain data values, each blockchain data value including at least a unique identifier and a genuineness flag; receiving, by a receiver of the processing server, a genuineness request, wherein the genuineness request includes at least a specific identifier associated with a product available for purchase; identifying, by a processing device of the processing server, a specific blockchain data value of the plurality of blockchain data values where the included unique identifier corresponds to the specific identifier; determining, by the processing device of the processing server, genuineness of the product available for purchase based on at least the genuineness flag included in the specific blockchain data value; and transmitting, by a transmitter of the processing device, the determined genuineness of the product.

A system for determining product genuineness includes: a memory of a processing server configured to store blockchain data for a blockchain, wherein the blockchain data includes a plurality of blockchain data values, each blockchain data value including at least a unique identifier and a genuineness flag; a receiver of the processing server configured to receive a genuineness request, wherein the genuineness request includes at least a specific identifier associated with a product available for purchase; a processing device of the processing server configured to identify a specific blockchain data value of the plurality of blockchain data values where the included unique identifier corresponds to the specific identifier, and determine genuineness of the product available for purchase based on at least the genuineness flag included in the specific blockchain data value; and a transmitter of the processing device configured to transmit the determined genuineness of the product.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for determining product genuineness via use of a blockchain in accordance with exemplary embodiments.

FIG. 2 is a block diagram illustrating the processing server of the system of FIG. 1 for determining product genuineness in accordance with exemplary embodiments.

FIG. 3 is a flow diagram illustrating a process for determining product genuineness as executed by the processing server of FIG. 2 in accordance with exemplary embodiments.

FIG. 4 is a flow chart illustrating an exemplary method for determining product genuineness in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Determining Product Genuineness Via Blockchain

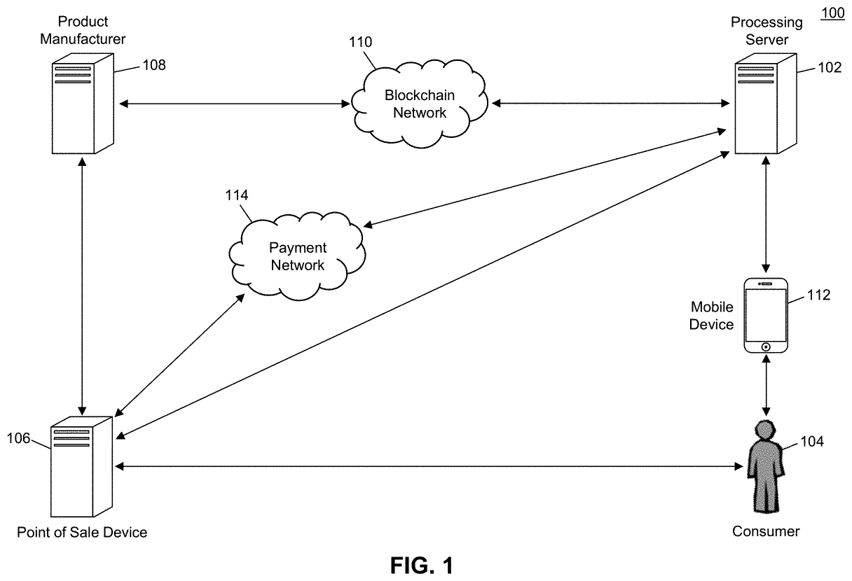

FIG. 1 illustrates a system 100 for the determination of the genuineness of a product being sold via the use of unique identifiers and a publicly accessible blockchain.

The system 100 may include a processing server 102. The processing server 102, discussed in more detail below, may be configured to determine if a product that is available for purchase is genuine, through the use of a publicly accessible blockchain that stores information regarding genuine products. In the system 100, a consumer 104 may wish to purchase a product from a merchant through a point of sale device 106 of that merchant. The consumer 104 may be interested in ensuring that the product they are purchasing is genuine (e.g., not fake or counterfeit) as made by the product manufacturer 108.

The product manufacturer 108 may manufacture products that are available to purchase from one or more merchants by consumers 104. As part of the manufacture of products, each product may be assigned a unique identifier that is unique to that individual product that will be available for purchase. The unique identifier may be any type of value suitable for use in performing the functions discussed herein, such as an integer value, alphanumeric value, etc. In some cases, the unique identifier may be of such sufficient complexity such that guessing of identifiers by a counterfeiter may be difficult or practically impossible. For example, the unique identifier may be a thirty-two digit alphanumeric value that is randomly or pseudo-randomly generated and not incremental, to where the creation of a counterfeit product by a counterfeiter with the same unique identifier would be nearly impossible. Unique identifiers for products may also be referred to herein as “product identifiers.”

The unique identifier for a product may be affixed thereto or otherwise accessible from the physical product itself. For instance, the unique identifier may be printed directly on the product or on a label that is affixed to the product. In another example, the unique identifier may be printed on a tag attached to the product that is removable after sale. In some cases, the unique identifier may be encoded in a machine-readable code displayed on or otherwise affixed to the product, such as being encoded in a bar code or quick response (QR) code that is readable via an optical imaging device.

The unique identifier for each product manufactured by the product manufacturer 108 may be stored in a blockchain that is publicly accessible by the processing server 102. The blockchain may be administered and managed by a blockchain network 110. The blockchain network 110 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 may be a blockchain node. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 110 prior to the generation and addition of a new block to the blockchain in order for the change to be made permanent. Computational and communication limitations may make such a modification exceedingly difficult, if not impossible, thus rendering the blockchain immutable.

Each blockchain data value may correspond to an entry for a manufactured product. An entry may include at least the product identifier unique to the related manufactured product. In some cases, additional information regarding a product may be included. For example, a product description (e.g., type, color, size, weight, dimensions, etc.) and/or other data, such as additional unique values, may also be stored in the blockchain data value for a manufactured product. Blockchain data values may also include data regarding the sale or resale of a manufactured product. For instance, a blockchain data value may include a flag that indicates if the entry is related to the sale of a manufactured product. In such cases, when a product is first manufactured, a new blockchain data value may be created that includes the product identifier with the sale flag not activated. When the product is purchased, a new blockchain data value may be created that includes the product identifier but with the flag activated, such that any subsequent purchase attempted by the consumer 104 will reveal that the product has already been sold previously.

When the product manufacturer 108 manufactures new products for sale, it may transmit the product identifiers (e.g., and any other accompanying information) to a node in the blockchain network. The node may create new blockchain data values for each product, which may then be included in one or more new blocks that are validated and added to the blockchain. The product manufacturer 108 may then distribute the products to merchants and make them available for purchase by consumers 104.

When the consumer 104 wants to purchase a product, a check may be performed to determine the genuineness of the product. As discussed herein, the check may be performed by the processing server 102. However, the check may be alternatively, or additionally, performed by the point of sale device 106 or a mobile device 112 of the consumer 104. The point of sale device 106 and mobile device 112 may thus be configured to perform each of the functions of the processing server 102 as discussed herein. The mobile device 112 may be any type of device specially configured to perform the functions discussed herein, such as a specially configured tablet computer, notebook computer, laptop computer, cellular phone, smart phone, smart watch, wearable computing device, implantable computing device, etc. In some embodiments, the check may be performed automatically as part of the attempted purchase of the product. In other embodiments, the consumer 104 or merchant may trigger the check. For instance, in one example, the check may be initiated by the consumer 104 using a mobile device 112, such as by scanning a machine-readable code on the product that is encoded with the product identifier using a suitable application program executed by the mobile device 112, where the check may be performed by the processing server 102 (e.g., at the request of the mobile device 112) or directly by the mobile device 112. In another example, the point of sale device 106 may initiate the check at the consumer's or merchant employee's request when the product is entered for purchase, or the check may be initiated automatically when the product is entered for purchase. In yet another example, a payment transaction for purchase of the product may be submitted for processing, where the processing server 102 may automatically perform the genuineness check as part of the processing of the payment transaction.

To check the genuineness of the product being purchased, the processing server 102 (e.g., or point of sale device 106 or mobile device 112, as applicable) may examine the blockchain data entries in the blockchain to identify any blockchain data values that include the unique identifier read from the product. If there is a single blockchain data value that includes the product identifier, then the product may be considered to be genuine. If there are multiple blockchain data values, the most recent (e.g., determined by the timestamp in the block header for the respective blocks) one may be identified and the processing server 102 may examine the flag therein to determine if the product has been sold, while still being genuine. If no blockchain data value is found that includes the unique identifier read from the product, then the product may be considered to be not genuine. In some cases, the product may have information included therein (e.g., in an affixed machine-readable code) that includes information identifying the block in which the original blockchain data entry for the product is stored, such as the timestamp, a block identifier, or other suitable value.

In embodiments where additional information is used alongside the product identifier, the processing server 102 may be configured to identify such information in the most recent blockchain data entry for the product. If possible, the processing server 102 may check for the accuracy of the additional information (e.g., if encoded in a machine-readable code associated with the product). In some cases, the additional information may be provided to the consumer 104 or an employee of the merchant (e.g., through the mobile device 112 or point of sale device 106) to check the additional information. For instance, a product description may be displayed on the mobile device 112 or point of sale device 106 that can be checked against the product being purchased. In an example, the product being purchase may be a handbag, where the blockchain data entry may include a product description that includes information regarding a special design stitched inside of the handbag. The consumer 104 and employee may check the inside of the handbag for the design to know if the product is genuine, as a further defense against a counterfeiter that may attempt to use the product identifier.

In another example, the additional information for a product may be comprised of a cryptographic key pair. In such a case, a cryptographic key pair may be generated for each product available for purchase, where the key pair is comprised of a public key and a private key. The private key may be used to generate a digital signature that is verifiable using the corresponding public key. In one case, the digital signature may be stored in the blockchain data value and the public key may be included with the product (e.g., encoded in a machine-readable code affixed thereto), which may be read and provided to the processing server 102. In such a case, the processing server 102 may verify the digital signature using the public key as part of the check for genuineness. In another case, the digital signature may be included with the product and the public key stored in the blockchain data entry, where the processing server 102 may verify the digital signature using the public key included in the blockchain data entry as part of the check for genuineness.

In some embodiments, the consumer 104 may be informed if a product is determined to be genuine or not genuine before processing of a payment transaction for purchase of the product. In such embodiments, a display device of the mobile device 112 or point of sale device 106 may display the results of the check for genuineness performed by the processing server 102 (e.g., or other device, as applicable). The consumer 104, being informed of the genuineness or lack thereof of the product, may then decide whether or not to purchase the product. To purchase the product, the point of sale device 106 may submit a payment transaction to a payment network 114 for processing.

The payment transaction may be submitted to the payment network 114 directly by the point of sale device 106 or through one or more intermediate entities, such as an acquiring bank or a gateway processor. The payment network 114 may receive transaction data for the payment transaction, which may be formatted in a transaction message (e.g., a specially formatted data message formatted according to one or more standards governing the exchange of financial transaction messages, such as the International Organization of Standardization's ISO 8583 or ISO 20022 standards) by the point of sale device 106 or intermediate entity. The payment network 114 may process the payment transaction using traditional methods and systems.

In embodiments where the genuineness check is performed during processing of the payment transaction, the payment network 114 may provide the product identifier to the processing server 102 during the processing of the payment transaction. The processing server 102 may then perform the genuineness check. In some embodiments, the processing may continue if the product is determined to be genuine, but may hold or stop if the product is determined to not be genuine. In some cases, if the product is not genuine, the transaction may be put on hold and the consumer 104 contacted (e.g., via the point of sale device 106) to prompt if the consumer 104 would like to continue the purchase or cancel the transaction, where the processing would continue or the transaction stopped based thereon. In other cases, if the product is not genuine, the transaction may be automatically declined. In such cases, the payment network 114 may return an authorization response to the point of sale device 106 with a response code indicating decline of the payment transaction. In some instances, the hold or stop of the transaction may occur if the product is genuine, but has previously been sold (e.g., where the consumer 104 may be informed of the product being for resale and provided with the option to continue or cancel the purchase).

The result is a system 100 where the consumer 104 is protected against the purchase of counterfeit products, and where a product manufacturer 108 can be sure that only genuine products are sold. The use of a publicly accessible blockchain, which can be used by the point of sale device 106, a mobile device 112, the processing server 102, or any entity to determine product genuineness, may ensure that anyone can easily check and verify the authenticity of a product for purchase, preventing any entity from being able to lie or game the system. The use of the blockchain and unique identifiers, particularly when combined with additional product information, can also ensure that a merchant does not unknowingly sell counterfeit products, preventing a counterfeiter from introducing counterfeit products among real products to be sold.

### Processing Server

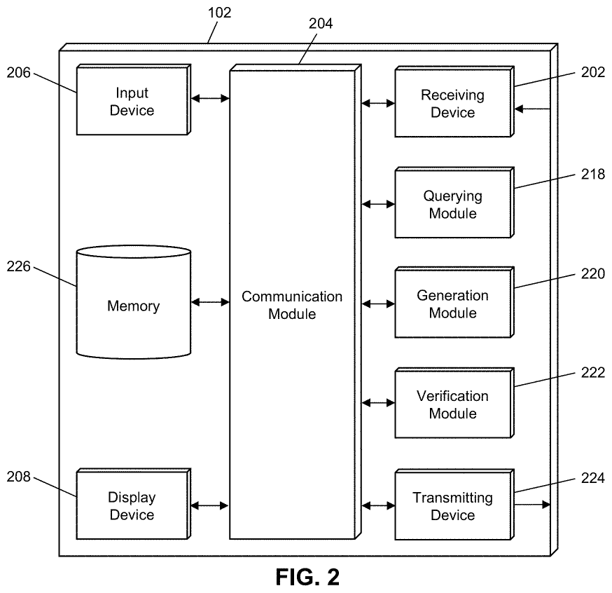

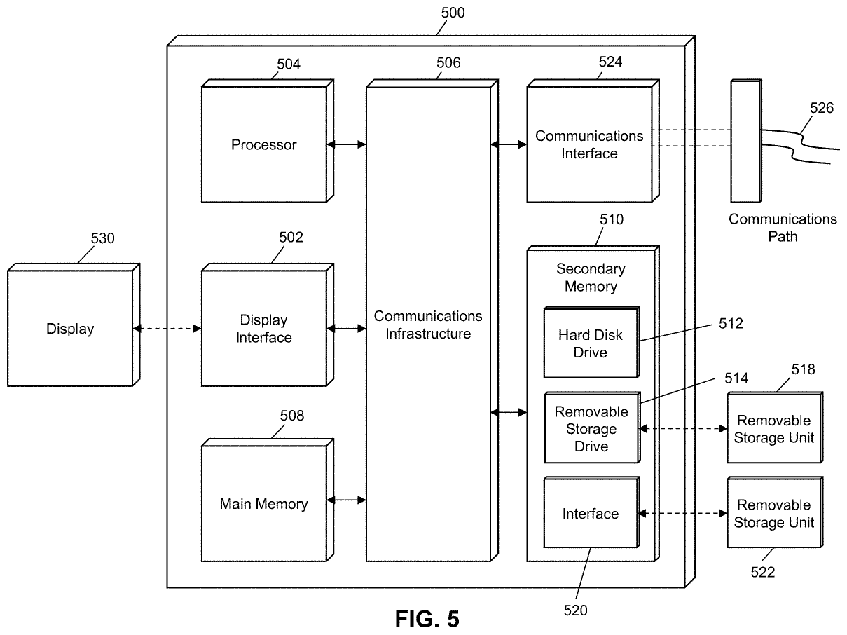

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102. It will also be apparent to persons having skill in the relevant art that the point of sale device 106 and mobile device 112 of FIG. 1 may be configured to include the components of and perform all of the functions of the processing server 102 as illustrated in FIG. 2 and discussed below, as discussed above in the system 100.

The processing server 102 may include a receiving device 202. The receiving device 202 may be configured to receive data over one or more networks via one or more network protocols. In some instances, the receiving device 202 may be configured to receive data from point of sale devices 106, mobile devices 112, blockchain networks 110, payment networks 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by point of sale devices 106 and mobile devices 112 that are superimposed or otherwise encoded with genuineness requests. A genuineness request may include at least a product identifier for a product for which a check for genuineness is being requested, and may also include any additional information to be used in the check, such as product information, public keys, digital signatures, etc. The receiving device 202 may also be configured to receive data signals from point of sale devices 106 and payment networks 114 that may be superimposed or otherwise encoded with transaction messages for payment transactions, which may include a product identifier along with other transaction data. The receiving device 202 may also be configured to receive data signals electronically transmitted by nodes in a blockchain network 110, which may be superimposed or otherwise encoded with blockchain data, including blockchain data entries.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, verification module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include or be otherwise interfaced with one or more input devices 206. The input devices 206 may be internal to the processing server 102 or external to the processing server 102 and connected thereto via one or more connections (e.g., wired or wireless) for the transmission of data to and/or from. The input devices 206 may be configured to receive input from a user of the processing server 102, which may be provided to another module or engine of the processing server 102 (e.g., via the communication module 204) for processing accordingly. Input devices 206 may include any type of input device suitable for receiving input for the performing of the functions discussed herein, such as a keyboard, mouse, click wheel, scroll wheel, microphone, touch screen, track pad, camera, optical imager, etc. The input device 206 may be configured to, for example, read a machine-readable code displayed on or affixed to a product that is encoded with a product identifier and any other information, receive input requesting a genuineness check be performed, etc.

The processing server 102 may also include or be otherwise interfaced with a display device 208. The display device 208 may be internal to the processing server 102 or external to the processing server 102 and connected thereto via one or more connections (e.g., wired or wireless) for the transmission of data to and/or from. The display device 208 may be configured to display data to a user of the processing server 102. The display device 208 may be any type of display suitable for displaying data as part of the functions discussed herein, such as a liquid crystal display, light emitting diode display, thin film transistor display, capacitive touch display, cathode ray tube display, light projection display, etc. In some instances, the processing server 102 may include multiple display devices 208. The display device 208 may be configured to, for example, display prompts to a consumer 104 or other user requesting further instructions regarding a genuineness check, display results of a genuineness check, etc.

The processing server 102 may include a querying module 218. The querying module 218 may be configured to execute queries on databases to identify information. The querying module 218 may receive one or more data values or query strings, and may execute a query string based thereon on an indicated database, such as a memory 226, to identify information stored therein. The querying module 218 may then output the identified information to an appropriate engine or module of the processing server 102 as necessary. The querying module 218 may, for example, execute a query on a memory 226 to identify blockchain data entries in a blockchain stored therein as part of the performing of a genuineness check.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to point of sale devices 106 and mobile devices 112 regarding genuineness checks or requests for instructions or information. The generation module 220 may also be configured to generate blockchain data entries, block headers, and blocks in embodiments where the processing server 102 may be a node in the blockchain network 110.

The processing server 102 may also include a verification module 222. The verification module 222 may be configured to perform verifications for the processing server 102 as part of the functions discussed herein. The verification module 222 may receive instructions as input, may attempt to verify data based on the instructions, and may output a result of the verification to another module or engine of the processing server 102. In some embodiments, the input may include the data to be verified by the verification module 222 and/or data to be used in the verification. In some cases, the verification module 222 may be configured to identify the data to be verified and/or used in the verification, such as in the memory 226 or read by the input device 206. The verification module 222 may be configured to check for genuineness of a product by verifying that a product identifier read therefrom matches a product identifier included in a blockchain data entry in the blockchain, and, if applicable, that a flag included therein indicates that the product is genuine (e.g., and unsold if applicable). In cases where digital signatures are used, the verification module 222 may be configured to verify a digital signature using a suitable public key, such as read from a product or included in a blockchain data entry.

The processing server 102 may also include a transmitting device 224. The transmitting device 224 may be configured to transmit data over one or more networks via one or more network protocols. In some instances, the transmitting device 224 may be configured to transmit data to point of sale devices 106, blockchain networks 110, mobile devices 112, payment networks 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to point of sale devices 106, mobile devices 112, and payment networks 114, which may be superimposed or otherwise encoded with data indicating results of a genuineness check or prompts for further actions regarding genuineness checks. The transmitting device 224 may also be configured to electronically transmit data signals to point of sale devices 106 and payment networks 114 that are superimposed or otherwise encoded with authorization responses for payment transactions. The transmitting device 224 may also be configured to electronically transmit data signals to nodes in a blockchain network 110, which may be superimposed or otherwise encoded with requests for blockchain data, or, in cases where the processing server 102 is a node in the blockchain network 110, blocks or blockchain data entries for validation and inclusion in the blockchain.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, hashing algorithms for generating blocks, credentials for validation, usage rule templates, communication data for blockchain nodes, communication data for mobile devices 112, point of sale devices 106, and payment networks 114, routing information for transaction messages, transaction message formatting standards, etc.

### Process for Determining Product Genuineness

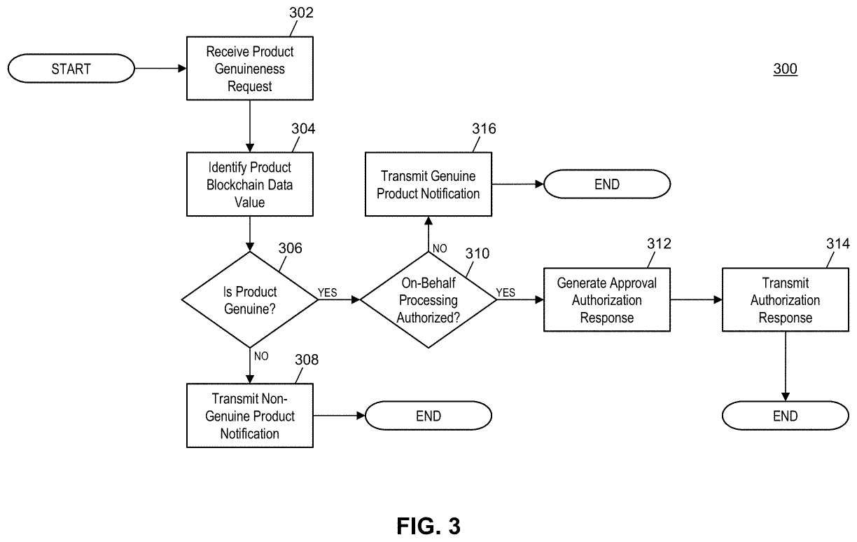

FIG. 3 illustrates an example process 300 for the determining of product genuineness in the system 100 of FIG. 1 as performed by the processing server 102. It will be apparent to persons having skill in the relevant art that the process 300 or steps included therein may alternative, or additionally, be performed by the point of sale device 106 or mobile device 112 of FIG. 1.

In step 302, the receiving device 202 of the processing server 102 may receive a request to check for the genuineness of a product. The request may include at least the product identifier for a product read therefrom, and may also include any additional information that may be used in the genuineness check as discussed herein. In step 304, the querying module 218 of the processing server 102 may execute a query on the memory 226 of the processing server 102 to identify any blockchain data values included in a copy of the blockchain stored therein that includes the product identifier included in the genuineness request.

In step 306, the processing server 102 may determine if the product is genuine. The product may be genuine if at least one blockchain data value including the product identifier was located in step 304. In cases where additional product information is included in the genuineness request, the determination may be further based on a check of the additional information against any other information included in the identified blockchain data values. In instances where multiple blockchain data values are identified, the genuineness may be further based on data included therein, such as where if resale is indicated (e.g., via a flag included in the blockchain data values), the product may not be considered genuine in some cases. If the product is not genuine, then, in step 308, the transmitting device 224 of the processing server 102 may electronically transmit a notification (e.g., to the point of sale device 106, mobile device 112, payment network 114, such as in an authorization response declining a transaction, etc.) indicating that the product is not genuine.

If the product is genuine, then, in step 310, the processing server 102 may determine if the processing server 102 is configured for on-behalf processing of a payment transaction for purchase of the product. If on-behalf processing is authorized (e.g., based on instructions of the payment network 114 or a financial institution involved in the payment transaction, such as the issuing bank for the consumer 104 purchasing the product), then, in step 312, the processing server 102 may generate an authorization response for the payment transaction that indicates that the payment transaction is approved (e.g., assuming approval for the payment transaction for other considerations, such as through traditional transaction processing). In step 314, the authorization response may be transmitted to the payment network 114 as part of the processing of the payment transaction. It will be apparent to persons having skill in the relevant art that steps 310 through 314 may only be performed in instances where the genuineness check is being performed as part of the processing of a payment transaction for purchase of the product.

If the product is genuine and on-behalf processing is not authorized (e.g., or the genuineness check is being requested outside of the context of the processing of a payment transaction), then, in step 316, the transmitting device 224 of the processing server 102 may electronically transmit a notification that the product was determined to be genuine. The notification may be transmitted in response to the request received in step 302, such as to the point of sale device 106, mobile device 112, or payment network 114. In some cases, the notification may be transmitted to a display device 208 interfaced with the processing server 102 for display thereon to a user, such as the consumer 104.

### Exemplary Method for Determining Product Genuineness

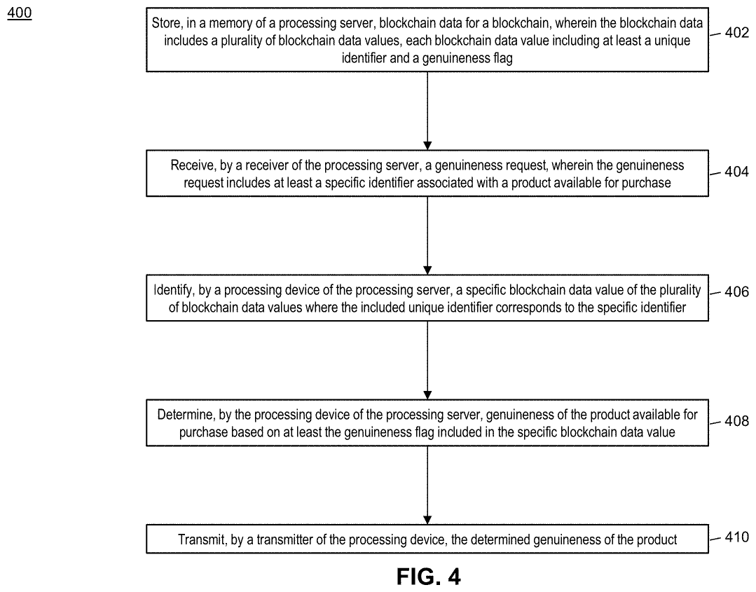

FIG. 4 illustrates a method 400 for determining the genuineness of a product available for purchase through the use of unique product identifiers and a publicly accessible blockchain.

In step 402, blockchain data for a blockchain may be stored in a memory (e.g., the memory 226) of a processing server (e.g., the processing server 102), wherein the blockchain data includes a plurality of blockchain data values, each blockchain data value including at least a unique identifier and a genuineness flag. In step 404, a genuineness request may be received by a receiver (e.g., the receiving device 202) of the processing server, wherein the genuineness request includes at least a specific identifier associated with a product available for purchase.

In step 406, a specific blockchain data value of the plurality of blockchain data values may be identified by a processing device (e.g., the querying module 218) of the processing server where the included unique identifier corresponds to the specific identifier. In step 408, genuineness of the product available for purchase may be determined by the processing device (e.g., the verification module 222) of the processing server based on at least the genuineness flag included in the specific blockchain data value. In step 410, the determined genuineness of the product may be transmitted by a transmitter (e.g., the transmitting device 224) of the processing server.

In one embodiment, each of the plurality of blockchain data values may further include a product description, and the product description included in the specific blockchain data value may be transmitted with the determined genuineness of the product. In some embodiments, the determined genuineness of the product may be transmitted to a mobile computing device (e.g., the mobile device 112). In a further embodiment, the genuineness request may be received from the mobile computing device.

In one embodiment, transmitting the determined genuineness of the product may include transmitting an authorization response formatted according to one or more standards, where the authorization response includes a plurality of data elements including at least a first data element configured to store a response code indicating a decline of an electronic payment transaction, and the response code or a second data element may indicate the decline of the electronic payment transaction due to the determined genuineness of the product indicating that the product is not genuine. In a further embodiment, the authorization response may be transmitted to a point of sale device (e.g., the point of sale device 106) involved in the electronic payment transaction.

In some embodiments, receiving the genuineness request may include reading, by an optical imaging device (e.g., the input device 206), a machine-readable code displayed on the product available for purchase, where the machine-readable code is encoded with the specific identifier. In one embodiment, the processing server may be a point of sale device (e.g., the point of sale device 106), and the determined genuineness of the product may be transmitted to a display device (e.g., the display device 208) interfaced with the point of sale device for display.

### Computer System Architecture

FIG. 5 illustrates a computer system 500 in which embodiments of the present disclosure, or portions thereof, may be implemented as computer-readable code. For example, the processing server 102, point of sale device 106, and mobile device 112 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for determining product genuineness. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining product genuineness, comprising:
storing, in a memory of a processing server, blockchain data for a blockchain, wherein the blockchain data includes a plurality of blockchain data values, each blockchain data value including at least a unique identifier and a genuineness flag;
receiving, by a receiver of the processing server, a genuineness request, wherein the genuineness request includes at least a specific identifier associated with a product available for purchase;
identifying, by a processing device of the processing server, a specific blockchain data value of the plurality of blockchain data values where the included unique identifier corresponds to the specific identifier;
determining, by the processing device of the processing server, genuineness of the product available for purchase based on at least the genuineness flag included in the specific blockchain data value; and
transmitting, by a transmitter of the processing device, the determined genuineness of the product.

2. The method of claim 1, wherein the determined genuineness of the product is transmitted to a mobile computing device.

3. The method of claim 2, wherein the genuineness request is received from the mobile computing device.

4. The method of claim 1, wherein
each of the plurality of blockchain data values further includes a product description, and
the product description included in the specific blockchain data value is transmitted with the determined genuineness of the product.

5. The method of claim 1, wherein
transmitting the determined genuineness of the product includes transmitting an authorization response formatted according to one or more standards, where the authorization response includes a plurality of data elements including at least a first data element configured to store a response code indicating a decline of an electronic payment transaction, and
the response code or a second data element indicates the decline of the electronic payment transaction due to the determined genuineness of the product indicating that the product is not genuine.

6. The method of claim 5, wherein the authorization response is transmitted to a point of sale device involved in the electronic payment transaction.

7. The method of claim 1, wherein receiving the genuineness request includes reading, by an optical imaging device, a machine-readable code displayed on the product available for purchase, where the machine-readable code is encoded with the specific identifier.

8. The method of claim 1, wherein
the processing server is a point of sale device, and
the determined genuineness of the product is transmitted to a display device interfaced with the point of sale device for display.

9. A system for determining product genuineness, comprising:
a memory of a processing server configured to store blockchain data for a blockchain, wherein the blockchain data includes a plurality of blockchain data values, each blockchain data value including at least a unique identifier and a genuineness flag;
a receiver of the processing server configured to receive a genuineness request, wherein the genuineness request includes at least a specific identifier associated with a product available for purchase;
a processing device of the processing server configured to
identify a specific blockchain data value of the plurality of blockchain data values where the included unique identifier corresponds to the specific identifier, and
determine genuineness of the product available for purchase based on at least the genuineness flag included in the specific blockchain data value; and
a transmitter of the processing device configured to transmit the determined genuineness of the product.

10. The system of claim 9, wherein the determined genuineness of the product is transmitted to a mobile computing device.

11. The system of claim 10, wherein the genuineness request is received from the mobile computing device.

12. The system of claim 9, wherein
each of the plurality of blockchain data values further includes a product description, and
the product description included in the specific blockchain data value is transmitted with the determined genuineness of the product.

13. The system of claim 9, wherein
transmitting the determined genuineness of the product includes transmitting an authorization response formatted according to one or more standards, where the authorization response includes a plurality of data elements including at least a first data element configured to store a response code indicating a decline of an electronic payment transaction, and
the response code or a second data element indicates the decline of the electronic payment transaction due to the determined genuineness of the product indicating that the product is not genuine.

14. The system of claim 13, wherein the authorization response is transmitted to a point of sale device involved in the electronic payment transaction.

15. The system of claim 9, wherein receiving the genuineness request includes reading, by an optical imaging device, a machine-readable code displayed on the product available for purchase, where the machine-readable code is encoded with the specific identifier.

16. The system of claim 9, wherein
the processing server is a point of sale device, and
the determined genuineness of the product is transmitted to a display device interfaced with the point of sale device for display.
